(19) United States
(12) Patent Application Publication
(10) Pub. No.: US 2014/0218169 A1
(43) Pub. Date: Aug. 7, 2014

(54) SECURITY DEVICE FOR EQUIPMENT INFORMATION AND THE OPERATION METHOD THEREOF

(71) Applicant: Claridy Solutions, Inc., Hsinchu (TW)

(72) Inventors: Jui-Ming CHIH, Hsinchu (TW); Horng-Ji CHEN, Hsinchu (TW); Yi-Ming CHEN, Hsinchu (TW)

(73) Assignee: Claridy Solutions, Inc., Hsinchu (TW)

(21) Appl. No.: 14/095,359

(22) Filed: Dec. 3, 2013

(30) Foreign Application Priority Data
Feb. 7, 2013 (TW) 102104792

(51) Int. Cl. G05B 1/03

(52) U.S. Cl. CPC G05B 1/03
USPC 340/5.81

(57) ABSTRACT

An equipment information security device is provided. The equipment information security device is installed on an equipment with confidential information, wherein the equipment or the device has a security interface, the device comprises: a fitting which is worn by a staff and combined with an electronic tag with or without authority to the corresponding equipment; a tag reader, which detects the electronic tag within a detecting area corresponding to the security interface; and an authority processing unit, which links to the tag reader: wherein the authority processing unit sets the security interface to an operation state and enables the security interface when there are only the authorized electronic tags being detected in the detecting area, and the authority processing unit sets the security interface to a security state and disables the security interface when one or more unauthorized electronic tags are detected in the detecting area.

### BACKGROUND OF THE INVENTION

1. Field of the Invention

The present invention relates to an equipment information security device and the operation method thereof. In particular, the present invention relates to an equipment information security device and the operation method which prevents the information of the equipment from being peeked or prevents the equipment from being operated by unauthorized personnel.

2. Description of the Related Art

In factories or workplaces, it is important to have equipment permission control in order to operate the manufacturing process or to prevent unauthorized person from operating the equipment to cause machine malfunction or even industrial safety accident. The implementation of the equipment permission control can be achieved, for example, by installing an identification device on each of the equipments. Therefore, a staff has to show his ID (such as an identification card containing a RFID tag or so called electronic tag) to the identification device of the equipment before operation. The staff cannot operate the equipment until his ID is authorized by the identification device. However, there may have suppliers or clients visiting or examining factories or workplaces. In general, the suppliers or clients do not need to operate equipments. However, if the equipment is operated by an authorized staff, the information or data of the equipment which is not protected appropriately then it is possible to be peeked by the unauthorized people, and therefore there is a risk of leakage of confidential.

Taiwan patent publication No. 201025066 discloses an automatic lock and unlock controls of a computer system and the method thereof, and the method includes the following steps. At first, the computer system is under an unlocked state and detects whether a user is within a predetermined range. If a user is outside of the predetermined range, the computer system records duration. Then, if the duration is longer than a predetermined time, the computer system turns to a locked state. If a user is detected within the predetermined range when the computer system is in the locked state, the computer will determine whether the user is authorized or not; if the user has the authority, then the computer turns to unlocked state. This patent application provides a kind of device permission control. However, if two or more users are detected within, the predetermined range simultaneously but some of the users do not have the authority, the computer still remains at unlocked state and then the operational information of the computer is likely to be leaked. Even though the unauthorized user does not operate the equipment directly, he still can peep at the interface of the equipment (such as a monitor or meter, etc.) to get the information of the equipment. Therefore, this problem causes the trade secret cannot be properly protected.

### SUMMARY OF THE INVENTION

The purpose of present invention is to provide an equipment information security device and the operation method thereof for solving the foregoing problems of the prior art. In particular, the present invention is to solve the problem that the information of equipment is peeked by an unauthorized person, which causes trade secret leakage.

To solve the foregoing problems, one aspect of the present invention is to provide an equipment information security device, which is installed on an equipment with confidential information (such as process procedure, recipe, etc.), wherein the equipment has a security interface; the device comprises: at least one fitting, which is worn/carried by a staff and is combined with an authorized or unauthorized electronic tag; a tag reader, which detects the electronic tag within a detecting area corresponding to the security interface; and an authority processing unit, which links to the tag reader; wherein the authority processing unit sets the state of the security interface to an operation state and enables the output and/or input interfaces when there are only the authorized electronic tags being detected in the detecting area, and, the authority processing unit sets the state of the security interface to a security state and disables the output and/or input interfaces while one or more unauthorized electronic tags are detected in the detecting area.

Another preferred object of the invention is that the equipment information security device further comprises a management system for determining whether the electronic tag possesses an authority to the equipment, and the management system stores a table/database of a corresponding relationship between the electronic tag and the equipment, and transmits the table/database to the authority processing unit.

Another preferred object of the invention is that said security interface is a display interface.

Another preferred object of the invention is that said security interface is an input interface.

Another preferred object of the invention is that the equipment information security device further comprises a sensor having a sensing area, wherein the tag reader stops reading or decreases reading times per unit time, and the authority processing unit switches to the security state when no person is being detected in the sensing area.

Another preferred object of the invention is that said sensor is an infrared sensor, a biological sensor, or an image sensor.

One more aspect of the invention is to provide an equipment information security device, and the security device is combined with an equipment, wherein the security device includes security interfaces, at least one fitting, one tag reader, and one authority processing unit. The security interface is connected with an output and/or input interfaces of the equipment. The fitting is worn/carried by a staff, is combined with an electronic tag with or without authority of the corresponding equipment. The tag reader detects the electronics tags within the detecting area of the corresponding security interface. The authority processing unit links with the tag reader and the security interface of the corresponding equipment, wherein the authority processing unit sets the state of the security interface to an operational state and enables the output and/or input interface while there are only the authorized electronic tags being detected in the detecting area; and the authority processing unit sets the state of the security interface to a security state and disables the output and/or input interface while one or more unauthorized tags are detected within the detecting area.

Another aspect of the invention is to provide an operational method for operating an equipment information security device, wherein there are at least one fitting combined with electronic tag for a staff to wear/carry, and an equipment, wherein there is a security interface on the equipment. The operational method comprises the following steps: (a) the electronic tag is paring with or without the authority of the operation of the corresponding equipment; (b) a tag reader detects whether all of the electronic tags in a detecting area have the authority corresponding to the equipment; (c) an authority processing unit sets the state of the security interface to an operation state and enables the security, interface of the equipment while there are only the electronic tags with authority being detected in the detecting area; and (d) under the operation state, if one or more unauthorized electronic tags are detected in the detecting area, the authority processing unit sets the security interface to a security state and disables the security interface.

Another preferred object of the invention is that the method further comprises a step (e) between the step (a) and step (b): if the electronic tag enters/leaves the detecting area, the management system then records the entering/leaving time of the electronic tag.

Another preferred object of the invention is that said device further comprises a sensor having a sensing area, and the method further comprises a step (f) between the step (a) and step (b): the tag reader stops reading or decreases reading times per unit time, and the authority processing unit disables the security interface when no staff is being detected in the sensing area.

Another preferred object of the invention is that said device further comprises a warning device, and the step (d) of the method further comprises: the warning device enables when there are one or more unauthorized electronic tags being detected in the detecting area.

Therefore, the present invention as the following benefits:

1. According to the equipment information security device of the present invention, the tag reader detects the electronic tag worn by the staff approaching to the equipment, and the authority processing unit checks the authority of the staff with respect to the equipment. If the tag reader detects an unauthorized staff entering into the detecting area, then the authority processing unit disables the security interface to protect the information of the equipment. Therefore, in such condition that the security interface is a display interface, the equipment information security device has the efficacy of preventing the information of the equipment from being peeked by the unauthorized people.

2. The sensor of the equipment information security device of the present invention detects the staff operating the equipment. If there is no staff in the sensing area, the tag reader then stops reading or decreases reading times per unit time, and disables the security interface. Therefore, if the person leaves the sensing area, the security interface is disabled immediately to maintain secrecy. It can also save electricity because the tag reader reduces the reading times per unit time and lower down the power consumption.

3. The management system of the equipment information security device of the present invention determines whether the electronic tag possesses an authority to the equipment, stores a table/database of a corresponding relationship between the electronic tag and the equipment, and records the time of the electronic tag entering or leaving the detecting area. Therefore, the facility manager can use the information of the management system as a reference to manage the equipment and people.

4. When an unauthorized staff is approaching to the equipment, the warning device of the equipment information security device of the present invention reminds and/or alerts the facility manager. Thus, it can also provide the facility manager with a reference for equipment and personnel management.

To improve understanding of the different aspects of the disclosure, the techniques employed in the patent invention to achieve the foregoing problems, characteristics and effects thereof are described hereinafter by the way of examples with reference to the accompanying drawings.

### BRIEF DESCRIPTION OF THE DRAWINGS

FIG. 1 shows a block diagram of an exemplary embodiment of the equipment information security device of the present invention.

FIGS. 2-1 to 2-2 shows flow chart of the operating method for the equipment information security device of the present invention.

FIGS. 3-1 to 3-4 shows an operating schematic diagram the equipment information security device of the present invention.

### DETAILED DESCRIPTION OF THE PREFERRED EMBODIMENTS

in the following detailed description, only certain exemplary embodiments the present invention are shown and described, by way of illustration. As those skilled in the art would recognize, the described exemplary embodiments may be modified in various way all without departing from the spirit or scope of the present invention.

The drawing and description are to be regarded as illustrative in nature, and not restrictive.

The technical contents of the present invention will become apparent with the detailed description of preferred embodiment.

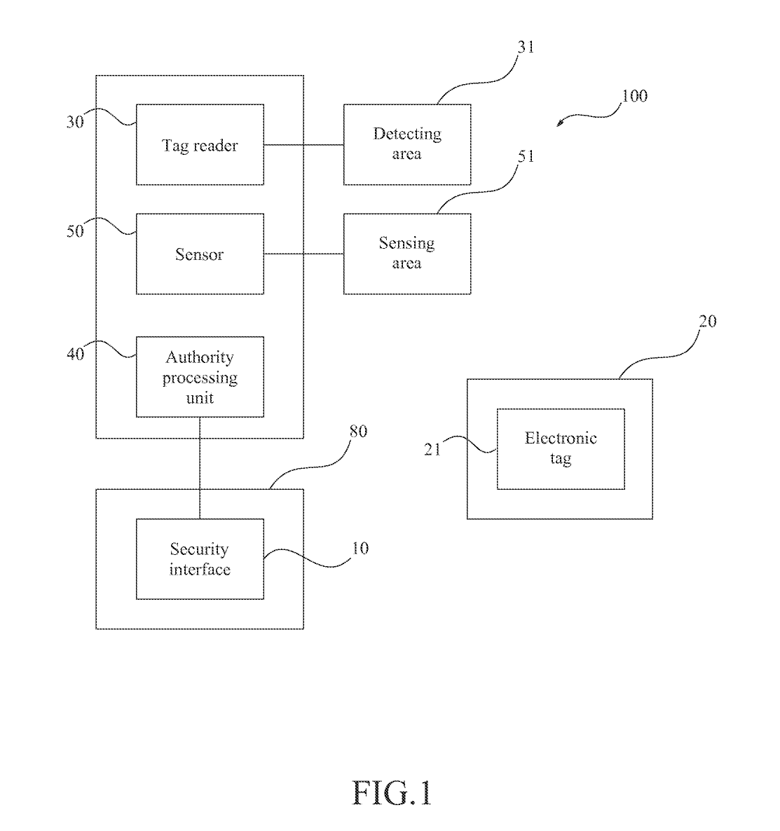

Please refer to FIG. 1, which shows a block diagram of the equipment information security device 100 of the present invention. The security device 100 is adapted to control the confidential information of an equipment 80. The equipment 80 comprises a security interface 10, and the security interface 10 is a human machine interface (HMI) which is an input interface for the user to operate the equipment 80, such as a keyboard, a mouse, or a controlling panel. The security interface 10 can also be a display interface for the user to view the operating condition or information of the equipment 80, such as a monitor, a meter, a dashboard, or a touch screen, etc. The security device 100 comprises a fitting 20, a tag reader 30 and an authority processing unit 40. The fitting 20 is worn or carried by a staff, and can be, but is not restricted to, a cloth, a hat, a head cover, a shoe cover, a wristband, an ID card, a clean room garment or an anti-static garment, etc. depending on different demands. The fitting 20 is combined with an electronic tag 21 by sewing, gumming or other attachment methods. The tag reader 30 has a detecting area 31 with electromagnetic wave or RF (radio frequency) field coupling to the electronic tag 21 within the detecting area 31 for communicating the information of the electronic tag 21.

In the exemplary embodiment, the tag reader 30 is a RFID reader, and the range of the detecting area 31 is the largest tag readable range of the tag reader 30 and is adjustable on demand with RF output power and antenna properties (such as antenna type, peak gain, etc.). The authority processing unit 40 is connected to the tag reader 30, and the authority processing unit 40 sets the security interface 10 to an operation state and enables the security interface 10 while there are only the authorized electronic tags 21 being detected in the detecting area 31, and the authority processing unit 40 sets the security interface, to a security state and disables the security interface 10 while one or more unauthorized electronic tags 21 are detected in the detecting area 31. The authority processing unit 40 is a data processor, having comparison and storage functions, and it can also execute the controlling software in the security device 100 without restriction. The way it enables/disables at the security interface 10, for example, is achieved by turning on/shutting down the power of the security interface 10, connect or disconnect the signal wires of the security interface 10, or an extra hardware or software is installed in the equipment 80 and is connected to and controlled by the authority processing unit 40 to enable/disable the security interface 10.

In another exemplary embodiment, considering that most of the equipments 80 are manufactured by different manufacturers, retrofitting extra hardware or software in the equipment 80 might be difficult. Therefore, the security interface 10 can be installed on the security device 100, and the input/output terminal (not shown) of the equipment 80 is connected to the security interface 10 for input/output signals so that the input/output signals are controlled by the authority processing unit 40 of the security device 100. Therefore, it is not necessary to install another software or hardware to the equipment 80 or retrofit the equipment 80 but the goal of controlling the input/output signals of the equipment 80 are achieved.

Additionally, the security device 100 further comprises a management system (not shown) for paring the electronic tags 21 with or without the authority of the operation of the corresponding equipments 80, and the management system stores a database of a corresponding relationship between the electronic tags 21 and the equipments 80. The management system further transmits the database to the authority processing unit 40 via network, digital communication or wireless communication. In fact, the management system is a control system independent to the security device 100. In this exemplary embodiment, the management system is responsible for establishing the relationship between the electronic tags 21 and the equipments 80, and providing the result of relationship to the authority processing units 40, but it does not to disturb the operating of the equipments 80.

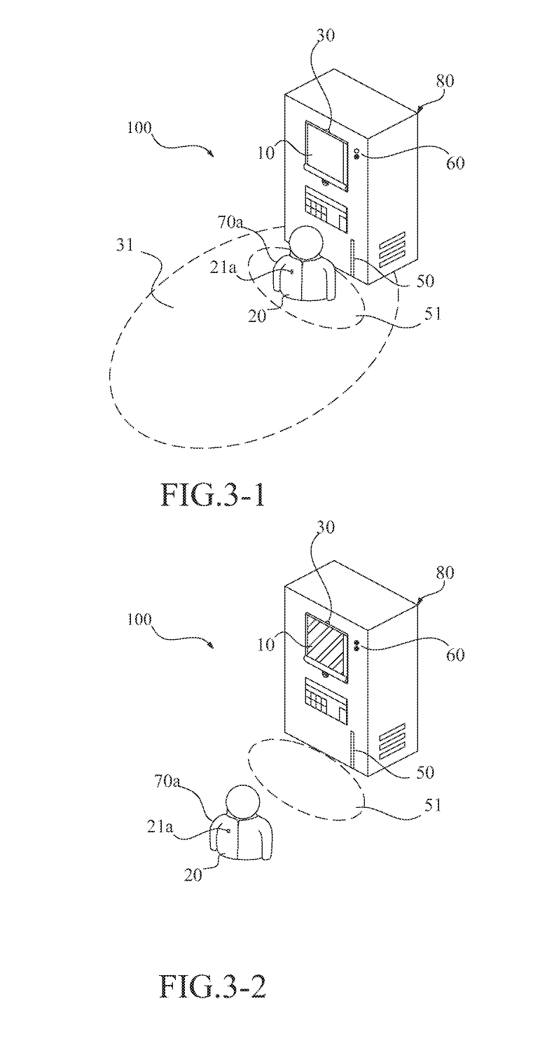

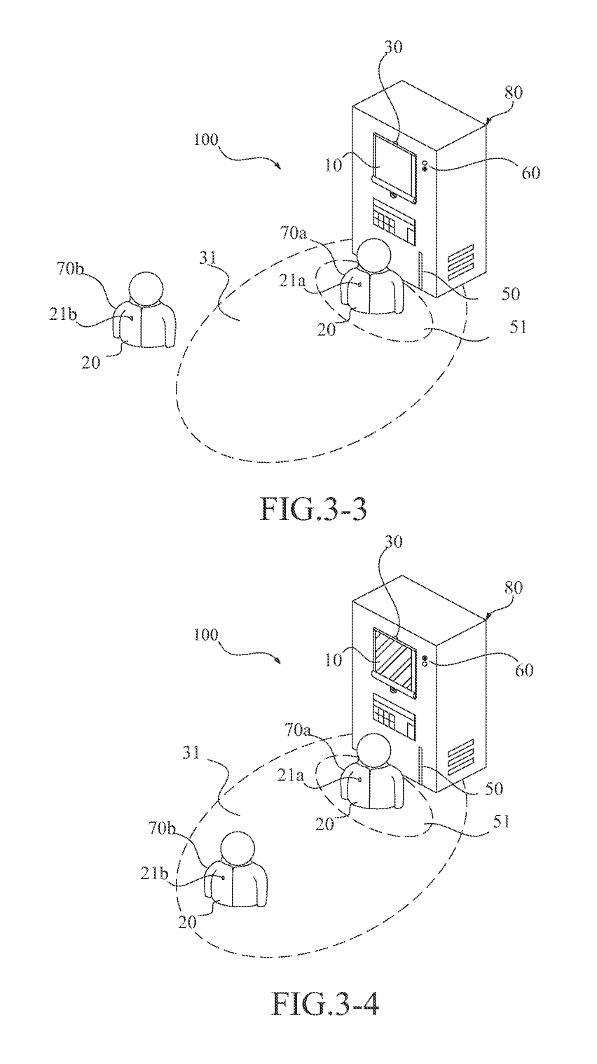

Preferably, the security device 100 is further installed with a sensor 50. The sensor 50 possesses the ability of detecting human beings, such as an infrared sensor, a biological sensor, or an image sensor, and the sensor 50 has a sensing area 51 which is smaller than the detecting area 31. Additionally, the security device 100 further comprises a warning device 60 (please refer to FIG. 3-1), and the warning device 60 can be a lamp or an alarm bell used to remind or to warn that there are some unauthorized staffs approaching to the equipment 80 and to apprises the facility manager. The warning device 60 can be used as a status light. For example, if there are only the authorized electronic tags 21 being detected in the detecting area 31, then the warning device 60 displays the status as “operating” (for example: a green light); if one or more electronic tags 21 without authority is being detected within the detecting area 31, then the warning device 60 displays the status as “warning” (for example: a red light); if there are no people being detected in the sensing area 51, then the warning device 60 turns off.

The electronic tag 21 of the embodiment of the present invention is a RFID (Radio Frequency Identification) tag operating in low frequency, high frequency, or ultra-high frequency bands. Preferably, in this exemplary embodiment, the electronic tag 21 attached to the fitting 20 is located on the central of forehead of the staff, because it is almost the same direction and close to the staff's eyes so that the tag reader 30 can detect the exact distance between security interface 10 and the eye's of the staff to avoid the unauthorized staff from peeking the information of the equipment 80. However, the electronic tag 21 can be located on knee of a staff or anywhere where it can be recognized by the tag reader 30 clearly. It should be understood that the position of the electronic tag 21 can be anywhere without restriction in the present invention.

The term “disable the security interface” used herein refers to switch the security interface 10, such as a monitor or screen, to a security state that people cannot see the information of the equipment 80 shown on the interface. For example, when the unauthorized staff enters into the detecting area 31, the security interface 10 hides all of the equipment information, or only displays a part of non-confidential information, or shutdowns the security interface 10 directly by the authority processing unit 40. If the security interface 10 is an input interface such as a keyboard or operating panel, it refers to switch the security interface 10 to the security state such that unable to input or is invalid input. As long as the manner of its security state to make the confidential information of the equipment 80 invisible, or make the security interface 10 inoperable or invalid, are in the present invention within the concept of “disabled”.

The term “detecting area” preferably refers to a range that a person can view the information displayed on the security interface 10 clearly. However, the tag reader 30 is coupled to the electronic tags 21 via electromagnetic wave or RF field, and if there are multiple tag readers 30, they will interfere to each other if the corresponding detecting areas 31 are too wide. In addition, a staff who is just walking by the detecting area 31 will be detected, causing the security interface 10 to be unnecessarily disabled and interrupting the authorized staff who is operating the equipment 80. Therefore, the detecting area 31 is adjustable by the RF output power of the tag readers 30 and the installation of the antennas to correspond with the working place. For example, in the condition that two equipments are set opposite to each other with a distance of 180 cm, then the ideal maximum distance of the detecting area 31 of the equipment is preferably 110 cm. The exemplary is just for illustrating the present invention but is not restricted to this distance value.

The term “sensing area” refers to an area defined by the sensor 50. The “sensing area” preferably is smaller than the detecting area 31. If the tag reader 30 continuously detects the electronic tag 21 in the detecting area 31 by electromagnetic coupling/communicating when there is no person approaching, then it costs lot of energy and makes vain detection. Therefore, the equipment information security device 100 of the present invention further comprises an infrared, biological or image sensor 50 for detecting whether a person is approaching the sensor 50 of the equipment 80, and the sensor 50 is served as a switch of the tag reader 30. The active range of the sensor 50 defines a sensing area 51; when a person enters into the sensing area 51, the tag reader 30 starts to read or recovers the normal reading times per unit time. The preferable sensing area 51 covers the area where a person is operating the security interface 10, such as the area in front of the keyboard, operating panel, or monitor of equipment, etc. It should he noticed that the preferable sensing area 51 is completely covered by the detecting area 31 to avoid the condition that the sensor 50 detects a person nearby the equipment 80 but no electronic tags 21 is detected by the tag reader 30. When the authorized person is trying to operate the equipment 80, he must enter into the sensing area Si and is detected by the sensor 50. On the contrary, when no person is detected in the sensing area 51, it means that determination of whether the electronic tag 21 has the authority is unnecessary; therefore, the tag reader 30 stops reading or decreases the reading times per unit time and disables the security interface 10 to prevent the information of the equipment 80 from being peeked or operated by an unauthorized person.

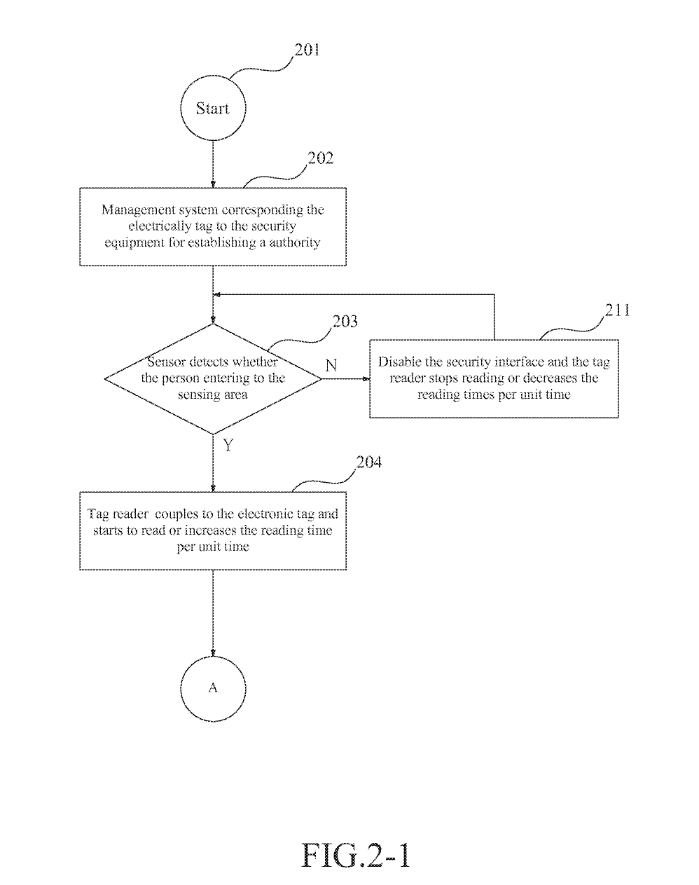

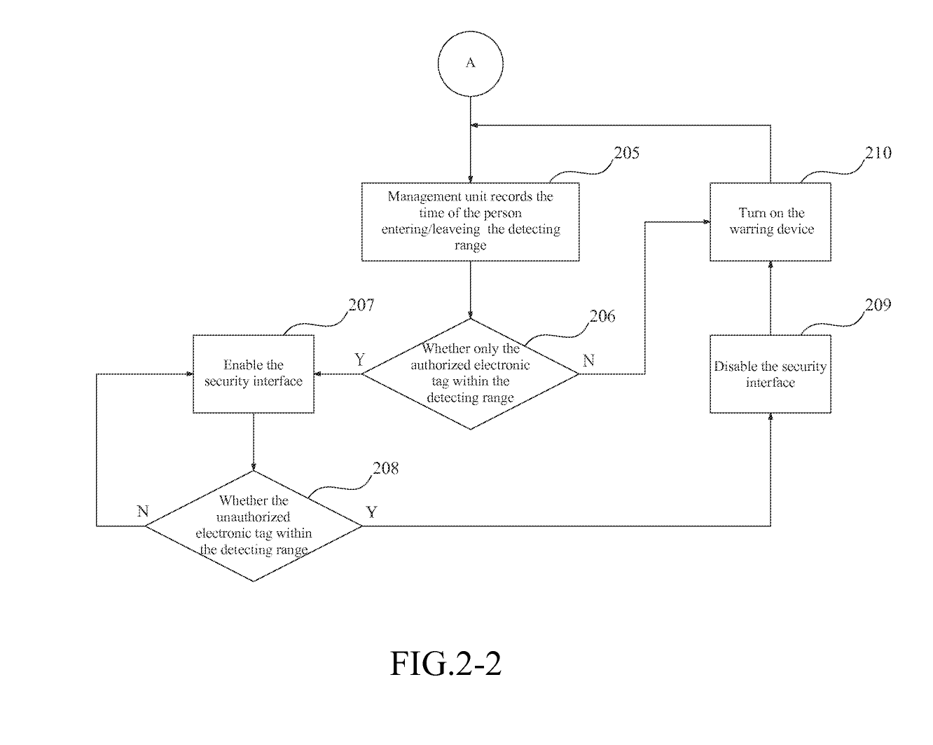

Please refer to FIGS. 2-1 to 2-2, showing an operation method flow chart of the equipment information security device 100 of the present invention. The method comprises at least the following steps as the figures shows:

First, the security device 100 starts (step 201); the management system has the electronic tag 21 couple to the equipment 80 to establish having or not having an authority corresponding to the equipment 80 (step 202); and the sensor 50 starts to detect whether a person enters into the sensing area 51 (step 203). If no one is detected in the sensing area 51 of the sensor 50, then the authority processing unit 40 disables the security interface 10 or keeps the security interface 10 disabled, and the tag reader 30 stops reading or decreases the reading times per unit time (step 211). If the sensor 50 detects a person in the sensing area 51, then the tag reader 30 starts or increases the reading times per unit time to obtain the information of the electronic tags 21 in the detecting area 31 by electromagnetic coupling/communicating (step 204). Since the person in the detecting area. 31 wears the fitting containing the electronic tag 21, the management system can record the time of the electronic tag 21 entering/leaving the detecting area 31 (step 205). Next, the authority processing unit 40 determines whether the electronic tags 21 in the detecting area 31 with authority to the equipment 80 (step 206). If there are only authorized electronic tags 21 being detected in the detecting area 31, it means all of the staffs approaching to the equipment 80 are authorized; therefore, the authority processing unit 40 sets the security interface 10 to an operation state and enables the security interface 10 (step 207). On the contrary, if one or more unauthorized electronic tags 21 are detected within the detecting area 31, then the security device 100 enables the warning device 60 (step 210). Under the operation state (step 207), the tag reader 30 continuously detects whether a staff without authority enters into the detecting area 31 (step 208); if the tag reader 30 detects an unauthorized electronic tag 21 in the detecting area 31, it means there is an unauthorized staff approaching to the equipment 80. In this situation, even if there are some authorized staffs in detecting area 31, the authority processing unit. 40 still sets the security interface 10 to the security state, disables the security interface 10 (step 209), and records the time of the unauthorized electronic tag 21 entering into the detecting area 31 in order to protect the information of the equipment 80 from being peeked. Also, the authority processing unit 40 enables the warning device 60 (step 210), the method goes back to the step 205 to continue the subsequent steps.

Additionally, in step 205, when the electronic tag 21 enters/leaves the detecting area 31, the management system records the entering/leaving time for recording the time of the staff (wearing the fitting which contains the electronic tag 21) entering/leaving the detecting area 31. It should be noticed that when the management system and the sensor 50 are used simultaneously, the staff who enters/leaves the sensing area 51 enables/disables the tag reader 30, leading to lack of the recording time that the staff is entering/leaving the detecting area 31. Therefore, while the tag reader 30 is enabling/disabling, the electronic tags 21 within the detecting area 31 is defined as entering/leaving the detecting area 31 to get the complete record for management.

Please refer to FIGS. 3-1 to 3-4 for a further embodiment of the present invention. The figures show an operating schematic diagram the equipment information security device 100 of the present invention. As FIG. 3-1 shows, a staff 70a wearing a fitting combined with an authorized electronic tag 21a approaches the equipment 80. Due to the staff 70a entering into the sensing area 51, the tag reader 30 determines whether the electronic tag 21a with authority to the equipment 80; if yes, then the authority management 40 sets the security interface to an operation state and enables the security interface 10, and the management system records the time of the staff 70a entering into the detecting area 31. Simultaneously, the warning device 60 displays the light as “operating”. When the staff 70a leaves the sensing area 51 as shown in FIG. 3-2, since the staff 70a is still in the detecting area 31 but is not sensed by the sensor 50 in the sensing area 51, the tag reader 30 stops reading or decreases the reading times per unit time to save energy. Also, the authority processing unit 40 disables the security interface 10 to prevent the information of the equipment 80 from being peeked or operated by an unauthorized staff. The management system records the time of the staff 70a leaving, and shuts down the warning device 60.

FIG. 3-3 shows another situation of the present invention. When a person 70a wearing the fitting combined with the authorized electronic tag 21a in the sensing area 51, the authority unit 40 sets the security interface 10 to an operation state and enables the security interface 10. At the same time, a staff 70b wearing the fitting combined with an unauthorized electronic tag 21b is outside of the detecting area 31. As shown in FIG. 3-4, when the staff 70b wearing the fitting combined with the unauthorized electronic tag 21b enters into the detecting area 31, then the tag reader 30 detects the unauthorized staff 70b, and the authority processing unit 40 sets the security interface 10 to a security state and disables the security interface 10 to prevent the information of the equipment 80 from being peeked or operated by the unauthorized person 70b. The management system records the time of the unauthorized person 70b entering into the detecting area 31, and the warning device 60 turns on the warning light to warn that the unauthorized person 70b is approaching to the equipment 80.

In conclusion, the equipment information security device of present invention detects the electronic tags in the detecting area via the tag reader, and determines whether the electronic tags with authority corresponding to the equipment. If the electronic tags in the detecting area all with authority, then e authority processing unit enables the security interface for the staffs wearing the fitting combined with authorized electronic tags to operate the equipment. When the authority processing unit sets the security interface 10 to a security state, if there is an unauthorized staff enters into the detecting area, then the authority processing unit disables the security interface to prevent the confidential information from being peeked. Additionally, the sensor of present invention can detect whether a staff is approaching to the security interface; when no one is detected by the sensor in the sensing area, then the tag reader stops reading or decreases the reading times per unit time to save energy. In addition, the facility manager can improve the control of the equipment because the management system has the database recording the time of the electronic tags entering/leaving the detecting area, and the warning device of present invention serves to warn or to remind the unauthorized staff approaching to the equipment.

While the present invention has been described in connection with certain exemplary embodiments, it is to be understood that the invention is not limited to the disclosed embodiment, but, on the contrary, is intended to cover various modifications and equivalent arrangement include within the spirit and scope of the appended claim, and equivalent thereof.

What is claimed is:

1. An equipment information security device, which is installed on an equipment with confidential information, wherein the equipment has a security interface; the device comprises:
at least one fitting, which is worn by a person and is combined with an electronic tag with or without authority of the corresponding equipment;
a tag reader, which detects the electronic tag within a detecting area corresponding to the security interface; and
an authority processing unit, which links to the tag reader;
wherein the authority processing unit sets the security interface to an operation state and enables the security interface when there are only authorized electronic tags being detected in the detecting area, and the authority processing unit sets the security interface to a security state and disables the security interface while one or more unauthorized electronic tags are detected in the detecting area.

2. The equipment information security device of claim 1, which further comprises a management system for determining whether the electronic tag possesses an authority to the equipment, and the management system stores a database of a corresponding relationship between the electronic tags and the equipment, and transmits the database to the authority processing unit.

3. The equipment information security device of claim 1, wherein the security interface is a display interface.

4. The equipment information security device of claim 1, wherein the security interface is an input interface.

5. The equipment information security device of claim 1, which further comprises a sensor having a sensing area, wherein the tag reader stops reading or decreases reading times per unit time, and the authority processing unit sets the security interface to a security state when no person is being detected in the sensing area.

6. The equipment information security device of claim 5, wherein the sensor is an infrared sensor, a biological sensor, or an image sensor.

7. An equipment information security device, which is installed on an equipment with confidential information; the device comprises:
a security interface, which is connected to an input connector and/or an output connector of the equipment;
at least one fitting, which is worn by a staff and combined with an electronic tag with or without authority of the corresponding equipment;
a tag reader, which detects the electronic tag within a detecting area corresponding to the security interface; and
an authority processing unit, which links to the tag reader;
wherein the authority processing unit sets the security interface to an operation state and enables the security interface when there are only the authorized electronic tags being detected in the detecting area, and the authority processing unit sets the security interface to a security state and disables the security interface while one or more unauthorized electronic tags are detected in the detecting area.

8. The equipment information security device of claim 7, which further comprises a management system for determining whether the electronic tag possesses an authority to the equipment, and the management system stores a database of a corresponding relationship between the electronic tags and the equipment, and transmits the database to the authority processing unit.

9. The equipment information security device of claim 7, wherein the security interface is a display interface.

10. The equipment information security device of claim 7, wherein the security interface is an input interface.

11. The equipment information security device of claim 7, which further comprises a sensor having a sensing area, wherein the tag reader stops reading or decreases reading times per unit time, and the authority processing unit sets the security interface to a security state when no person is being detected in the sensing area.

12. The equipment information security device of claim 11, wherein the sensor is an infrared sensor, a biological sensor, or an image sensor.

13. A method for operating an equipment information security device, wherein the security device has at least one fitting for a staff to wear, and the fitting is combined with an electronic tag; the method comprises the following steps:
(a) the electronic tag is coupled to an equipment with confidential information to establish with or without authority to the corresponding equipment;
(b) a tag reader detects whether all of the electronic tags in a detecting area have the authority corresponding to the equipment;
(c) an authority processing unit sets a security interface to an operation state and enables the security interface of the equipment when there are only the electronic tags with authority being detected in the detecting area; and
(d) under the operation state, if one or more unauthorized electronic tags are detected in the detecting range, the authority processing unit sets the security interface to a security state and disables the security interface.

14. The method of claim 13, wherein the device further comprises a management system for determining whether the electronic tag possesses an authority to the equipment, and the management system stores a database of a corresponding relationship between the electronic tags and the equipment, and transmits the database to the authority processing unit.

15. The method of claim 14, which further comprises a step (e) between the step (a) and step (b): if the electronic tag enters/leaves the detecting range, the management system then records the entering/leaving time of the electronic tag.

16. The method of claim 13, wherein the device further comprises a sensor having a sensing area, and the method further comprises a step (f) between the step (a) and step (b): the tag reader stops reading or decreases reading times per unit time and the authority processing unit disables the security interface when no person is being detected in the sensing area.

17. The method of claim 16, wherein the sensor is an infrared sensor, a biological sensor, or an image sensor.

18. The method of claim 13, wherein the device further comprises a warning device, and the step (d) of the method further comprises: the warning device enables when there are one or more unauthorized electronic tags being detected in the detecting range.
